(19) United States
(12) Patent Application Publication
(10) Pub. No.: US 2026/0367559 A1
(43) Pub. Date: Nov. 19, 2026

(54) IMAGE FORMING APPARATUS, FOGGING MARGIN SETTING METHOD, AND STORAGE MEDIUM

(71) Applicant: Konica Minolta, Inc., Tokyo (JP)

(72) Inventor: Futoshi OKAZAKI, Toyokawa-shi (JP)

(21) Appl. No.: 19/674,703

(22) Filed: May 12, 2026

(30) Foreign Application Priority Data
May 13, 2025 (JP) 2025-080491

(51) Int. Cl. G03G 15/00; G03G 15/043

(52) U.S. Cl. CPC G03G 15/5054; G03G 15/043; G03G 15/55; G03G 2215/00059

(57) ABSTRACT

An image forming apparatus includes: a sensor configured to detect a toner amount of a fogged image formed on an image bearing member; and a hardware processor that: makes a stepwise change to a fogging margin; acquires the toner amount of the fogged image formed on the image bearing member according to the stepwise change in the fogging margin, the toner amount being detected by the sensor; and sets the fogging margin based on the acquired toner amount. The fogging margin includes a first fogging margin in a non-image region, and the hardware processor sets the first fogging margin to a value corresponding to a predetermined difference value with respect to a saturation value of the acquired toner amount.

### CROSS-REFERENCE TO RELATED APPLICATION

The entire disclosure of Japanese Patent Application No. 2025-080491 filed on May 13, 2025, is incorporated herein by reference in its entirety.

### BACKGROUND OF THE INVENTION

### Technical Field

The present disclosure relates to an image forming apparatus, a fogging margin setting method, and a storage medium.

### Description of Related Art

Conventionally, electrophotographic image forming apparatuses that form images on sheets are known. An electrophotographic image forming apparatus develops, with toner, an electrostatic latent image formed on a photoreceptor, transfers the toner image to a sheet in a transfer section, and fixes the toner image in a fixing section. In an electrophotographic image forming apparatus, toner remaining on the photoreceptor is removed by a blade member.

In an electrophotographic image forming apparatus, toner mixed with lubricant particles is supplied from a developing device to a photoreceptor at a predetermined timing to form a fogged image. Accordingly, a frictional force between an edge of the blade member and the photoreceptor can be reduced. Accordingly, wear on the photoreceptor and the blade member can be suppressed, thereby extending the service lives of the photoreceptor and the blade member.

However, in a system in which lubricant particles are supplied from a developing device, the amount supplied varies depending on the state of the developing device or the developer, which presents an issue. For example, when the amount of developer on a developer carrier is small, or when the gap between the developer carrier and the photoreceptor is wide, the supply of the lubricant particles tends to be insufficient. Further, when the charge amount of the developer or the toner ratio suppresses toner flight onto the surface of the photoreceptor, the supply of the lubricant particles is likewise insufficient. Accordingly, in general, the fogging margin is appropriately set such that the amount of fogging toner attached to the photoreceptor is neither excessive nor insufficient. The fogging margin is the difference between the charging output and the developing output.

Consequently, control methods that vary the toner amount between an image region and a non-image region are known. For example, a control method is known in which the setting value for the image region is set to produce a normal, clean result, while the setting value for the non-image region is set to supply a deficient amount of toner. In this case, the criteria for varying the toner amount are based on assumed values that are predetermined in accordance with usage conditions, such as image coverage, the number of pixels, the number of printed sheets, and ambient temperature and humidity.

However, the assumed values used in the above-described control method for varying the toner amount cannot fully account for unforeseeable conditions, making it difficult to control the toner amount accurately. Examples of such unforeseeable conditions include variations due to assembly tolerances in the developing device or the photoreceptor unit, as well as changes in the state of the developer that occur with each print. Further, while the fogging margin is typically set in a table and varies depending on, for example, ambient temperature and humidity and durability history, variations attributable to the states of individual developing devices, developers, and drum units including photoreceptors are not taken into consideration. This makes it difficult to appropriately set the fogging margin.

Accordingly, to encompass the various variations described above, a configuration has been disclosed in which the amount of fogging toner attached to a photoreceptor, a transfer belt, or the like is directly read (see, for example, Japanese Unexamined Patent Application Publication No. 2023-58347). Specifically, in the configuration described in Japanese Unexamined Patent Application Publication No. 2023-58347, the amount of fogging toner attached to a photoreceptor or a transfer belt is directly read, and the fogging margin is determined based on the change in that amount when the fogging margin is varied stepwise. According to the configuration described in Japanese Unexamined Patent Application Publication No. 2023-58347, it is possible to accurately track changes in the amount of fogging toner due to the various variations described above.

### SUMMARY OF THE INVENTION

In the image region, it is necessary to limit the fogging toner amount to a level that prevents contamination of the image surface (so-called fogging). The configuration described in Japanese Unexamined Patent Application Publication No. 2023-58347 is an effective means for calculating an appropriate fogging margin in the image region.

However, for example, when the supply of lubricant particles to the photoreceptor is insufficient, it is necessary to increase the fogging toner amount in the non-image region to compensate for the insufficient supply of the lubricant particles. In this case, the configuration described in Japanese Unexamined Patent Application Publication No. 2023-58347 has a problem in that an appropriate fogging margin cannot be calculated because the fogging toner amount in the non-image region varies significantly due to various variations.

An object of the present disclosure is to provide an image forming apparatus, a fogging margin setting method, and a storage medium capable of extending the service lives of a photoreceptor and a blade member while maintaining the image quality in the image region.

To achieve at least one of the above-mentioned objects, an image forming apparatus reflecting one aspect of the present invention comprises: a sensor configured to detect a toner amount of a fogged image formed on an image bearing member; and a hardware processor that: makes a stepwise change to a fogging margin; acquires the toner amount of the fogged image formed on the image bearing member according to the stepwise change in the fogging margin, the toner amount being detected by the sensor; and sets the fogging margin based on the acquired toner amount, wherein the fogging margin includes a first fogging margin in a non-image region, and the hardware processor sets the first fogging margin to a value corresponding to a predetermined difference value with respect to a saturation value of the acquired toner amount.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram illustrating a schematic configuration of an image forming apparatus according to the present embodiment;

FIG. 2 is a functional block diagram illustrating a control configuration of the image forming apparatus according to the present embodiment;

FIG. 3 is a diagram illustrating an exposure section, a charging section, a developing section, and a drum unit for forming a certain color, which are disposed along an intermediate transfer belt;

FIG. 4 is a flowchart illustrating an example of control performed by the image forming apparatus according to the present embodiment;

FIG. 5 is a graph illustrating output characteristics when a sensing section detects a fogging toner amount on the intermediate transfer belt;

FIG. 6 is a graph illustrating the output characteristics shown in FIG. 5, averaged over three points;

FIG. 7 is a graph illustrating the differences in the output characteristics shown in FIG. 6;

FIG. 8 is a graph illustrating the relationship between a threshold value Vth and Voffset for setting a background fogging margin corresponding to an image region in the graph shown in FIG. 7;

FIG. 9 is a graph showing the relationship between a saturation point and a threshold value Vzth for setting an inter-image fogging margin corresponding to a non-image region in the graph shown in FIG. 6;

FIG. 10 is a diagram illustrating a conceptual framework of the toner amount supplied onto a photoreceptor;

FIG. 11 is a diagram illustrating a conceptual framework of an appropriate toner amount supplied onto the photoreceptor according to the present embodiment;

FIG. 12 is a graph illustrating the relationship between a plot in the graph shown in FIG. 7 and ranks of background fogging corresponding to the image region;

FIG. 13 is a graph illustrating an example in which the inter-image fogging margins are determined for units having different conditions, based on the prior example;

FIG. 14 is a graph illustrating an example in which the inter-image fogging margins are determined for units having different conditions, based on the present disclosure;

and FIG. 15 is a diagram illustrating an example of a configuration in which the sensing section is disposed at a position facing the photoreceptor.

### DETAILED DESCRIPTION

Hereinafter, one or more embodiments of the present invention will be described with reference to the drawings. However, the scope of the invention is not limited to the disclosed embodiments.

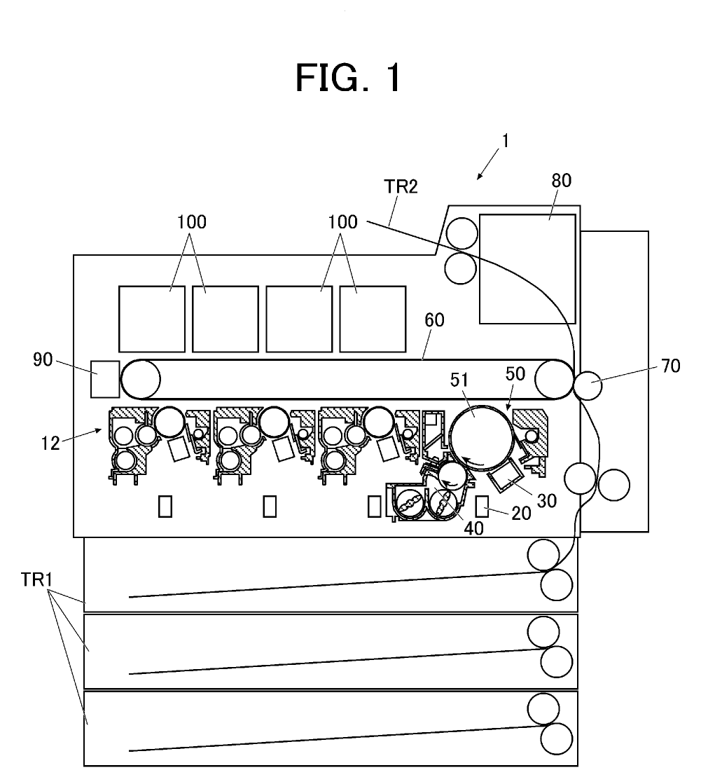

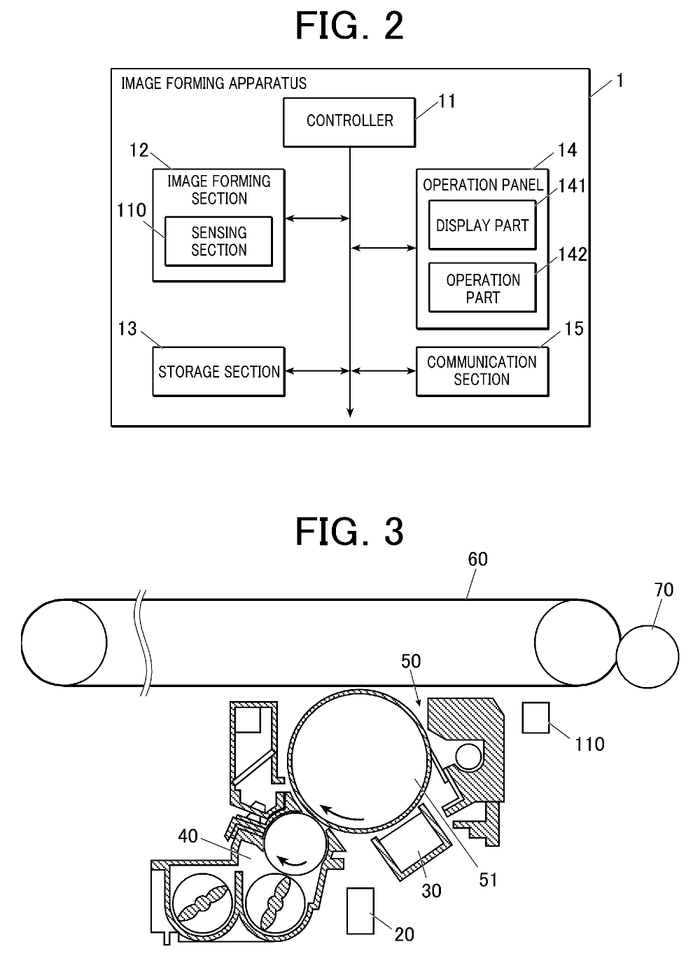

As illustrated in FIGS. 1 and 2, the image forming apparatus 1 according to the present embodiment includes a controller (hardware processor) 11, an image forming section 12, a storage section 13, an operation panel 14, and a communication section 15.

The controller 11 includes a CPU, RAM, and ROM. In response to an operation signal input from an operation part 142 or an instruction signal received by the communication section 15, the CPU first reads various programs stored in the ROM and develops them in the RAM. Then, the CPU centrally controls the operation of the image forming apparatus 1 in cooperation with the various programs developed in the RAM.

The image forming section 12 forms an image of four colors of Y, M, C, and K on a sheet, according to the pixel values of the four colors of each pixel of the original image subjected to image processing. As shown in FIG. 1, the image forming section 12 includes exposure sections (exposurers) 20, charging sections 30, developing sections 40, drum units 50, an intermediate transfer belt 60, secondary transfer rollers 70, a fixing section 80, a cleaning section 90, toner supply sections 100, a sensing section (sensor) 110 (see FIG. 3), and the like. One of the exposure sections 20, one of the charging sections 30, one of the developing sections 40, and one of the drum units 50 are provided for each of the colors Y, M, C, and K. The exposure section 20, the charging section 30, the developing section 40, and the drum unit 50 are disposed in series (tandem) along the belt surface of the intermediate transfer belt 60 and form an image of each of the colors Y, M, C, and K. The drum unit 50 includes a photoreceptor 51. Above the intermediate transfer belt 60, the toner supply sections 100 respectively containing replenishment developers for the respective colors Y, M, C, and K are disposed.

When forming an image, the image forming section 12 first charges the photoreceptor 51 using the charging section 30. Thereafter, the photoreceptor 51 is scanned with a light beam emitted from the exposure section 20 based on an original image, thereby forming an electrostatic latent image. That is, the exposure section 20 forms an electrostatic latent image on the charged photoreceptor 51. Next, the developing section 40 supplies a color material such as toner to perform development. As a result, an image (a toner image) is formed on the photoreceptor 51.

The images respectively formed on the photoreceptors 51 are sequentially superimposed and primarily transferred onto the intermediate transfer belt 60 by respective primary transfer rollers (not shown). As a result, a composite image of the colors is formed on the intermediate transfer belt 60. The intermediate transfer belt 60 rotates by being looped around a plurality of rollers. After the primary transfer, the cleaning section 90 removes the color material remaining on each photoreceptor 51.

In the image forming section 12, a sheet is fed from a sheet feed tray TR1 in accordance with the timing at which the image on the rotating intermediate transfer belt 60 reaches the position of the secondary transfer rollers 70. One of the paired secondary transfer rollers 70 is pressed against the intermediate transfer belt 60, and the other constitutes one of a plurality of rollers around which the intermediate transfer belt 60 is looped. The image forming section 12 secondarily transfers the image from the intermediate transfer belt 60 onto the sheet by pressing the one of the secondary transfer rollers 70 against the intermediate transfer belt 60. Thereafter, the image forming section 12 conveys the sheet to the fixing section 80 to cause the fixing section 80 to perform fixing processing and ejects the sheet to a sheet ejection tray TR2. In the fixing processing, the sheet is heated and pressed to fix the image onto the sheet. The cleaning section 90 removes residue (e.g., residual toner) remaining on the intermediate transfer belt 60 after the secondary transfer.

The storage section 13 is a nonvolatile storage means including a hard disk drive (HDD), a solid-state drive (SSD), or the like. The storage section 13 stores various programs, various setting data, and the like in a readable and writable manner from the controller 11.

As illustrated in FIG. 2, the operation panel 14 includes a display part 141 that displays various information to a user, and the operation part 142 that receives operation inputs from the user.

The display part 141 includes a color liquid crystal display or the like. The display part 141 displays an operation screen or the like in accordance with a display control signal input from the controller 11. The operation screen or the like includes, for example, various setting screens, various buttons, operating statuses of respective functions, or the like.

The operation part 142 includes a touch screen provided on the screen of the display part 141 and various hard keys arranged near the screen of the display part 141. When a button displayed on the screen is pressed with a finger, a touch pen, or the like, the operation part 142 first detects X- and Y-coordinates of the pressed position in terms of voltage values. Next, the operation part 142 outputs, to the controller 11, an operation signal associated with the detected position. The touch screen is not limited to a resistive type and may be, for example, a capacitive type or an optical type. When a hard key is pressed, the operation part 142 outputs, to the controller 11, an operation signal associated with the pressed key. The user can operate the operation part 142 to perform operations such as configuring settings related to image formation, issuing sheet conveyance instructions, and stopping the apparatus. The settings related to image formation include, for example, image quality settings, magnification settings, application settings, output settings, and sheet settings.

The communication section 15 includes a communication IC and a communication connector and serves as an interface for connecting the image forming apparatus 1 to a communication network. Under the control of the controller 11, the communication section 15 transmits and receives various kinds of information to and from an external device connected to the communication network using a predetermined communication protocol. The communication section 15 can also input and output various kinds of information via USB.

FIG. 3 is a diagram illustrating the exposure section 20, the charging section 30, the developing section 40, and the drum unit 50 for forming a certain color, which are disposed along the intermediate transfer belt 60.

As shown in FIG. 3, the sensing section 110 is disposed at a position separated from the intermediate transfer belt 60 by a certain distance. The sensing section 110 detects the toner amount of a fogged image formed on an image bearing member (the intermediate transfer belt 60).

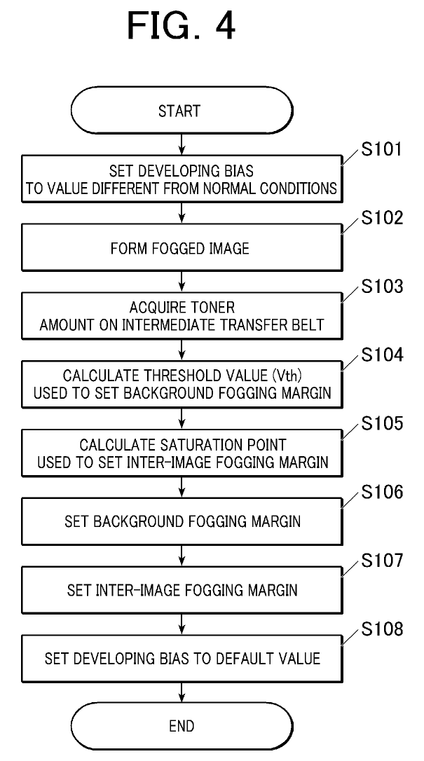

Next, the control by the image forming apparatus 1 according to the present embodiment will be described with reference to the flowchart of FIG. 4. The control shown in FIG. 4 is initiated when certain conditions arise that suggest a change or adjustment is necessary (such as when the apparatus is used for the first time, when the ambient environment changes, or when the number of printed sheets increases).

First, the controller 11 sets the developing bias (here, the duty ratio of the AC waveform) to a value (e.g., 25%) that differs from the normal setting (step S101). The normal setting refers to the setting used during image formation for a print job. This facilitates detection of fogging.

Next, the controller 11 causes the image forming section 12 to form a fogged image (step S102). In this step, the controller 11 makes a stepwise change to the fogging margin (e.g., in increments of 10 V). That is, the controller 11 functions as a changing section of the present disclosure. Accordingly, the controller 11 causes the image forming section 12 to form a fogged image while making a stepwise change to the fogging margin.

Next, the controller 11 acquires the toner amount on the intermediate transfer belt 60 detected by the sensing section 110 (step S103). In this step, the sensing section 110 detects the toner amount on the intermediate transfer belt 60 when the fogging margin is changed, for example, in increments of 10 V. Specifically, the controller 11 acquires, as detected by the sensing section 110, the toner amount of the fogged image formed on the image bearing member (the intermediate transfer belt 60) according to the stepwise change in the fogging margin. That is, the controller 11 functions as an acquisition section of the present disclosure.

Next, the controller 11 calculates a threshold value (Vth) used to set a background fogging margin in an image region (second fogging margin) (step S104). Vth indicates the threshold value at which the change (i.e., the difference) in the output of the sensing section 110 due to the fogging margin becomes substantially zero. Vth is set to a value substantially close to zero (see FIG. 8).

Next, the controller 11 calculates a saturation point P2 used to set an inter-image fogging margin in a non-image region (first fogging margin) (step S105). The saturation point is the point at which the output increases and reaches a peak as the fogging margin is increased, or the point corresponding to the maximum value among the detected outputs.

Next, the controller 11 sets the background fogging margin in the image region (step S106). Specifically, the controller 11 extracts, as a change point P1, the point (i.e., the fogging margin value) at which the output change (difference) first becomes less than Vth calculated in step S104, starting from the side with the lower fogging margin (see FIG. 8). Next, the controller 11 sets the background fogging margin MA1 to a value obtained by adding the value of Voffset, referred to as the offset margin, to the change point P1 (see FIG. 8). That is, the controller 11 sets the background fogging margin MA1 in the image region based on the change point P1 of the toner amount acquired in step S103.

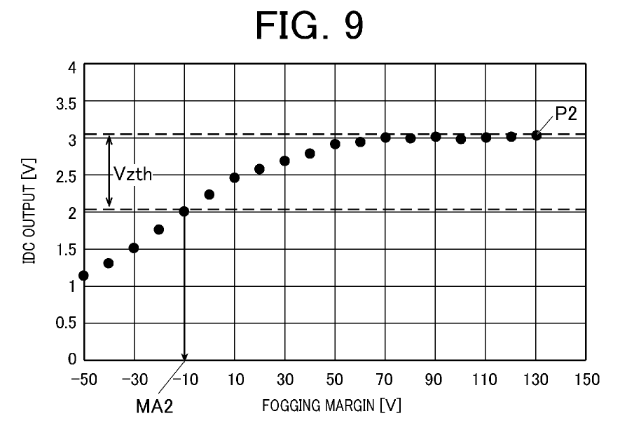

Next, the controller 11 sets the inter-image fogging margin in the non-image region (step S107). Specifically, the controller 11 sets an inter-image fogging margin MA2 to the fogging margin corresponding to a predetermined output difference (Vzth) from the value at the saturation point P2 (saturation value) calculated in step S105 (see FIG. 9). That is, the controller 11 sets the inter-image fogging margin MA2 in the non-image region to a value corresponding to the predetermined difference value (Vzth) with respect to the saturation value of the toner amount acquired in step S103.

Next, the controller 11 sets the developing bias to the default value (e.g., 50%) (step S108).

As described above, the controller 11 sets the fogging margins (background fogging margin, inter-image fogging margin) based on the toner amount acquired in step S103. That is, the controller 11 functions as a setting section of the present disclosure.

In the present embodiment, as described above, the setting methods differ between the background fogging margin in the image region (second fogging margin) and the inter-image fogging margin in the non-image region (first fogging margin). Accordingly, the fogging margin in the image region and the fogging margin in the non-image region basically have different values. Even when the setting methods differ, the values may be the same. That is, the fogging margin in the image region and the fogging margin in the non-image region may have the same value.

Note that, in the present embodiment, the exposure section 20 does not form an electrostatic latent image in the non-image region. In the present embodiment, since the toner amount is controlled solely by the fogging margin, it is not necessary to form an electrostatic latent image in the non-image region followed by forcibly forming an image.

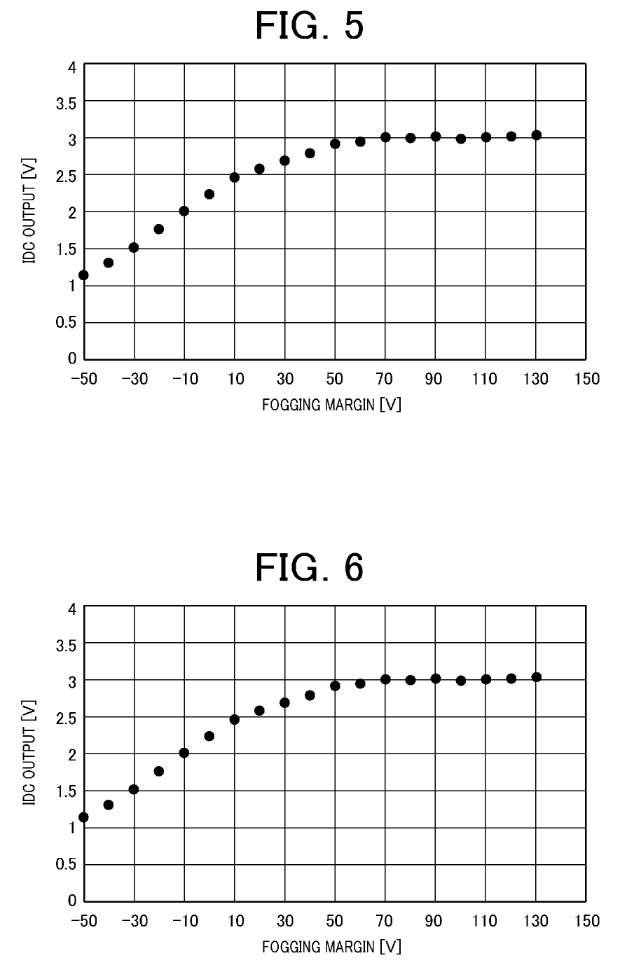

FIG. 5 is a graph illustrating output characteristics when the sensing section 110 detects the fogging toner amount on the intermediate transfer belt 60. Specifically, FIG. 5 is a graph in which the output of the sensing section 110 (the toner amount on the intermediate transfer belt 60) is plotted when the fogging margin is changed, for example, in increments of 10 V. In FIG. 5 and the like, the output of the sensing section 110 is labeled as an IDC output. The sensing section 110 detects the reflectance of the toner on the intermediate transfer belt 60 and outputs the detected reflectance. When the toner amount is large, the amount of reflected light decreases, and thus the output of the sensing section 110 decreases. Conversely, when the toner amount is small, the amount of reflected light increases, and thus the output of the sensing section 110 increases. Note that, in the example illustrated in FIG. 5, the output of the sensing section 110 saturates at approximately 3 V. This results from calibration performed within the operating range of the sensing section 110, and the output does not need to saturate at approximately 3 V.

FIG. 6 is a graph illustrating the output characteristics shown in FIG. 5, averaged over three points. Specifically, FIG. 6 replots the output data from the sensing section 110 at each fogging margin as the average of the output values from the sensing section 110 at three consecutive fogging margins.

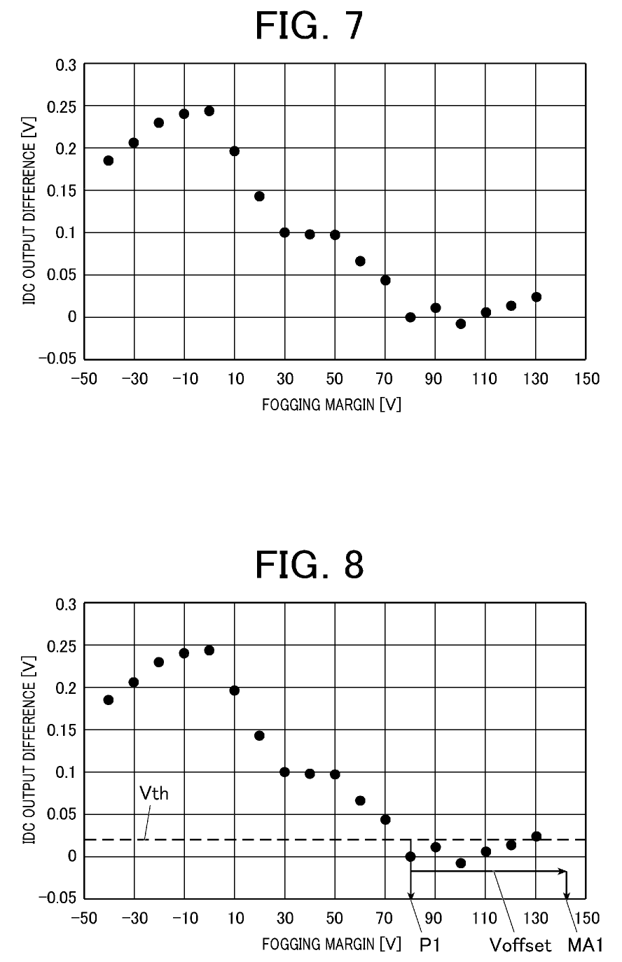

FIG. 7 is a graph illustrating the differences in the output characteristics shown in FIG. 6. Specifically, FIG. 7 plots the differences in the three-point averaged values in FIG. 6 when the fogging margin is changed, using the side with the lower fogging margin as the reference point. As shown in FIGS. 6 and 7, the greater the change in output when the fogging margin is changed, the greater the difference; conversely, the smaller the change in output, the smaller the difference. When there is no change at all in output when the fogging margin is changed, the difference is substantially zero.

FIG. 8 is a graph illustrating the relationship between the threshold values Vth and Voffset for setting the background fogging margin MA1 corresponding to the image region in the graph shown in FIG. 7. Vth indicates the threshold value at which the change (i.e., the difference) in the output of the sensing section 110 due to the fogging margin becomes substantially zero. Vth is set to a value substantially close to zero. The point at which the difference falls below Vth when the fogging margin is increased by a large amount indicates that substantially no toner remains on the intermediate transfer belt 60 and that, even when the fogging margin is further increased, the fogging toner will not change. Here, the point at which the difference first falls below Vth when starting from the side with the lower fogging margin is defined as the change point P1. The actual background fogging margin MA1 is set to a value obtained by adding the value of Voffset, referred to as the offset margin, to the change point P1. Note that, for Voffset, values set according to toner color, speed, and the like may be prepared in advance.

FIG. 9 is a graph showing the relationship between the saturation point P2 and a threshold value Vzth for setting the inter-image fogging margin MA2 corresponding to the non-image region in the graph shown in FIG. 6. As the fogging margin is increased, the output of the sensing section 110 increases and eventually saturates at a certain value. The inter-image fogging margin MA2 is most suitably set to the fogging margin corresponding to a predetermined output difference (Vzth) from the value at the saturation point P2. The saturation point P2 is defined as the point at which the output increases and reaches a peak as the fogging margin is increased, or the point corresponding to the maximum value among the detected outputs.

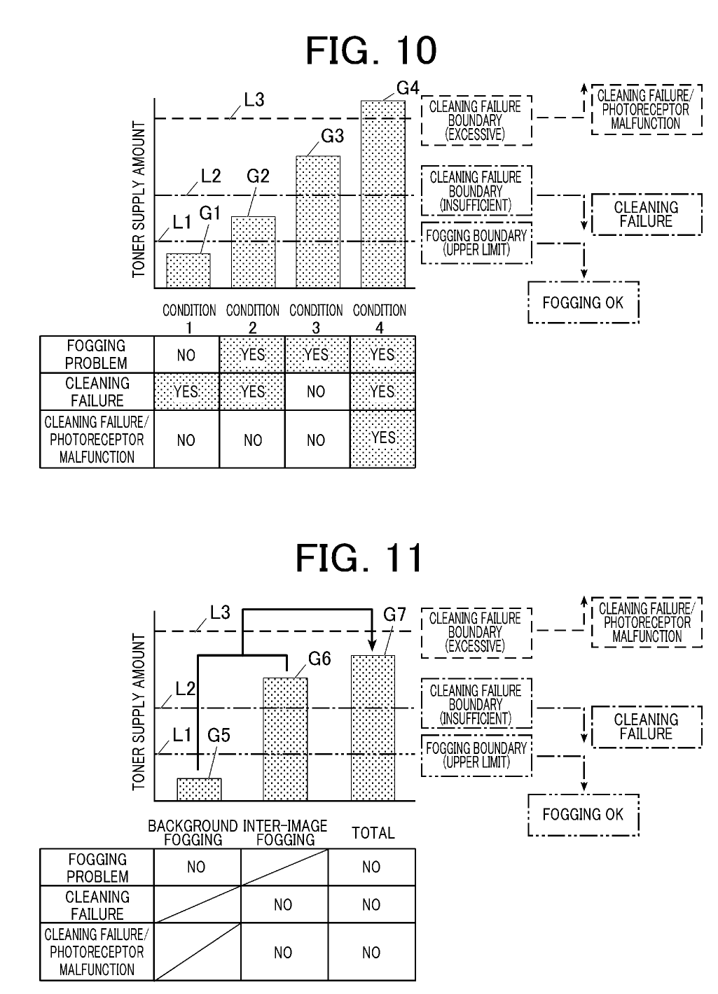

FIG. 10 is a diagram illustrating a conceptual framework of the toner amount supplied onto the photoreceptor 51. The bar graphs G1 to G4 shown in FIG. 10 represent the supply amounts of toner present on the photoreceptor 51 under Conditions 1 to 4, respectively. Three dashed lines L1 to L3 are shown on the vertical axis. The lowermost dashed line L1 indicates the upper limit of the fogging toner amount, which is the threshold at which image fogging does not occur. The middle dashed line L2 indicates the lower limit of the toner amount, which is the threshold at which cleaning failures due to insufficient toner do not occur. The uppermost dashed line L3 indicates the upper limit of the toner amount, which is the threshold at which cleaning failures or malfunctions of the photoreceptor 51 due to excessive toner do not occur.

The bar graph G1 for Condition 1 falls below the lowermost dashed line L1 and represents a toner supply amount when there are no problems at all with the fogged image. However, since the bar graph G1 for Condition 1 also falls below the middle dashed line L2, the bar graph G1 represents a toner supply amount at which cleaning failures occur due to insufficient toner.

The bar graph G2 for Condition 2 exceeds the lowermost dashed line L1 and represents a toner supply amount when there is a problem with the fogged image. In addition, since the bar graph G2 for Condition 2 falls below the middle dashed line L2, the bar graph G2 represents a toner supply amount at which cleaning failures occur due to insufficient toner.

The bar graph G3 for Condition 3 exceeds the lowermost dashed line L1 and represents a toner supply amount when there is a problem with the fogged image. In addition, since the bar graph G3 for Condition 3 exceeds the middle dashed line L2, the bar graph G3 represents a toner supply amount at which cleaning failures due to insufficient toner do not occur. In addition, since the bar graph G3 for Condition 3 falls below the uppermost dashed line L3, the bar graph G3 represents a toner supply amount at which cleaning failures or malfunctions of the photoreceptor 51 due to excessive toner do not occur.

The bar graph G4 for Condition 4 exceeds the lowermost dashed line L1 and represents a toner supply amount when there is a problem with the fogged image. In addition, since the bar graph G4 for Condition 4 exceeds the middle dashed line L2, the bar graph G4 represents a toner supply amount at which cleaning failures due to insufficient toner do not occur. In addition, since the bar graph G4 for Condition 4 exceeds the uppermost dashed line L3, the bar graph G4 represents a toner supply amount at which cleaning failures or malfunctions of the photoreceptor 51 occur due to excessive toner.

Note that each of the bar graphs G1 to G4 represents the average toner supply amount per image, indicating that the toner amounts for Conditions 1 to 4 are supplied continuously.

FIG. 11 is a diagram illustrating a conceptual framework of the appropriate toner amount supplied onto the photoreceptor 51 according to the present embodiment. In FIG. 11, three bar graphs G5 to G7 representing the supply amounts of toner present on the photoreceptor 51 are shown. The left bar graph G5 represents the toner supply amount in the image region. The middle bar graph G6 represents the toner supply amount in the non-image region. The right bar graph G7 represents the toner supply amount in the image region plus the non-image region (i.e., the toner supply amount per sheet). On the vertical axis of FIG. 11, the three dashed lines L1 to L3 are shown as in FIG. 10.

The left (background fogging) bar graph G5 falls below the lowermost dashed line L1 and represents a toner supply amount when there are no problems at all with the fogged image.

Since the middle (inter-image fogging) bar graph G6 exceeds the middle dashed line L2, the bar graph G6 represents a toner supply amount at which cleaning failures due to insufficient toner do not occur. In addition, since the middle bar graph G6 falls below the uppermost dashed line L3, the bar graph G6 represents a toner supply amount at which cleaning failures or malfunctions of the photoreceptor 51 due to excessive toner do not occur.

Since the right (total) bar graph G7 is the sum of the left bar graph G5 and the middle bar graph G6, neither image fogging nor any issue related to cleaning or the photoreceptor 51 occurs.

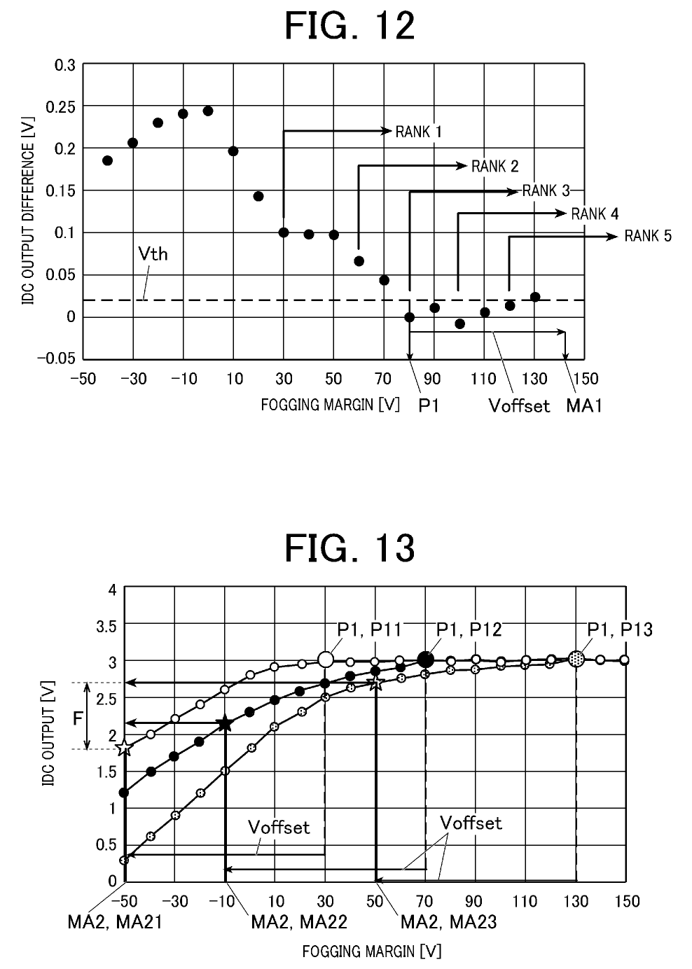

FIG. 12 is a graph illustrating the relationship between the plot in the graph shown in FIG. 7 and ranks of the background fogging corresponding to the image region. In the example shown in FIG. 12, the fogging is represented in approximately five ranks (Ranks 1 to 5), ranging from a poor state to a good state. Rank 1 indicates a state in which the presence of a fogged image is obvious to anyone. Rank 2 indicates a state in which some people may notice the fogged image. Rank 3 indicates a state in which most people do not notice the fogged image. Rank 4 indicates a state in which almost no one can recognize the fogged image. Rank 5 indicates a state in which no fogging toner associated with the fogging is present on the image. In general, as long as Rank 3 or higher is achieved, no image-related complaints occur in the market. That is, as shown in FIG. 12, it can be seen that Rank 1 and Rank 2 correspond to regions where the difference in the three-point average is large, the change point P1 corresponds approximately to Rank 3, and regions beyond the change point P1 correspond to Rank 4 and Rank 5.

FIG. 13 is a graph illustrating an example in which the inter-image fogging margins are determined for units having different conditions, based on the prior example. The phrase "units having different conditions" refers to a situation where, for example, in a particular unit (developing section 40), conditions differ due to changes in the state of the toner within that developing section 40. Accordingly, this indicates that even with the same fogging margin, the amount of fogging toner attached to the photoreceptor 51 may differ depending on the conditions of the unit. The prior example refers to a conceptual framework (configuration) for determining the background fogging margin according to a fog detection method in the present disclosure. More specifically, the prior example involves a configuration in which the background fogging margin and the inter-image fogging margin are set to values obtained by taking into account the offset margin (Voffset) at the change point. In the example shown in FIG. 13, the inter-image fogging margins MA2 are set to values obtained by taking into account the value of the offset margin (Voffset) at the respective change points P1. For fogged images in the image region, there is no problem as long as the rank of the images is Rank 3 or higher, as described with reference to FIG. 12. Therefore, for each unit having different conditions, the change point P1 is obtained, as indicated by a circle (change points P11 to P13). In the example shown in FIG. 13, it can be seen that the output of the sensing section 110 differs significantly across the inter-image fogging margins MA2 (MA21 to MA23) respectively calculated for the units having different conditions (see reference sign F in the drawing), where the values obtained by taking into account the offset margin (Voffset) respectively at the change points P1 (P11 to P13) are defined as the inter-image fogging margins MA2 (MA21 to MA23). That is, it can be seen that the amount of inter-image fogging varies significantly among units having different conditions.

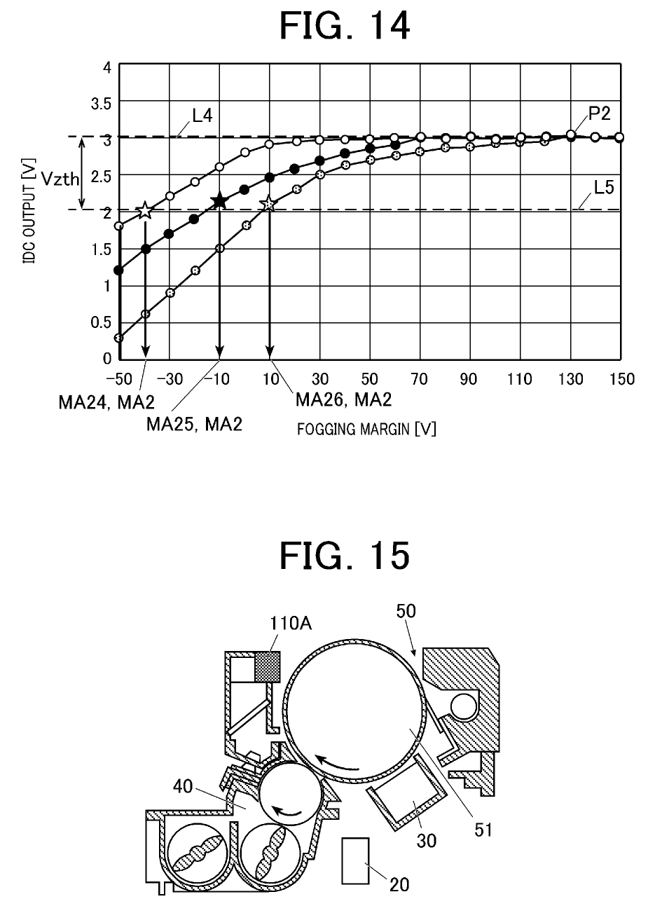

FIG. 14 is a graph illustrating an example in which the inter-image fogging margins are determined for units having different conditions, based on the present disclosure. The upper dashed line L4 corresponds to the saturation point P2 described with reference to FIG. 9. The lower dashed line L5 indicates the point corresponding to the predetermined output difference (Vzth) from the saturation point P2. The lower dashed line L5 indicates that the toner amount on the intermediate transfer belt 60 is the same. That is, when the inter-image fogging margins MA2 are set to fogging margins MA24 to MA26 indicated by the points at which the lines of output obtained for the units having different conditions intersect with the lower dashed line L5, the amount of inter-image fogging becomes substantially the same even among the units having different conditions.

As described above, the image forming apparatus 1 according to the present embodiment includes a changing section (controller 11), an acquisition section (controller 11), and a setting section (controller 11). The changing section makes a stepwise change to the fogging margin. The acquisition section acquires the toner amount of a fogged image formed on the image bearing member according to the stepwise change in the fogging margin by the changing section. The toner amount is detected by the sensing section 110. The setting section sets the fogging margin based on the toner amount acquired by the acquisition section. The setting section sets the fogging margin in the non-image region (first fogging margin) to a value corresponding to a predetermined difference value with respect to the saturation value of the toner amount acquired by the acquisition section.

Therefore, according to the image forming apparatus 1 of the present embodiment, an appropriate fogging margin in the non-image region can be calculated, and an optimal fogging toner amount can be supplied in the non-image region. Accordingly, while maintaining the image quality in the image region, the service lives of the photoreceptor 51 and the blade member can be extended.

Also, the setting section sets the fogging margin in the image region (second fogging margin) based on the change point of the toner amount acquired by the acquisition section.

Therefore, an appropriate fogging margin in the image region can be calculated, and an optimal fogging toner amount can be supplied in the image region. Accordingly, the image quality in the image region can be appropriately maintained.

Further, the fogging margin in the image region and the fogging margin in the non-image region have different values.

Accordingly, an appropriate fogging margin can be calculated for each of the image region and the non-image region. Accordingly, while maintaining the image quality in the image region, the service lives of the photoreceptor 51 and the blade member can be extended.

Further, the fogging margin in the image region and the fogging margin in the non-image region can have the same value.

Accordingly, an appropriate fogging margin can be calculated for each of the image region and the non-image region. Accordingly, while maintaining the image quality in the image region, the service lives of the photoreceptor 51 and the blade member can be extended.

The image forming apparatus further includes an exposure section 20 that forms an electrostatic latent image on the charged photoreceptor 51. The exposure section 20 does not form an electrostatic latent image in the non-image region.

Therefore, it is possible to eliminate the need to form an electrostatic latent image in the non-image region followed by forcibly forming an image. Therefore, an optimal fogging toner amount can be accurately supplied to the non-image region.

Although specific description has been given above based on the embodiment according to the present disclosure, the present disclosure is not limited to the above-described embodiment, and changes can be made without departing from the spirit and scope of the present disclosure.

For example, in the above-described embodiment, a configuration in which the sensing section 110 detects the state of a toner image on the intermediate transfer belt 60 has been described as an example. However, the present disclosure is not limited thereto.

FIG. 15 illustrates an example of a configuration in which a sensing section 110A is disposed at a position facing the photoreceptor 51. In this case, the sensing section 110A detects the toner amount of a fogged image formed on the photoreceptor (image bearing member) 51.

In the above-described embodiment, a configuration that includes the operation panel 14 has been described as an example. However, the present disclosure is not limited thereto. In other words, the operation panel 14 is not an essential component, and a configuration without the operation panel 14 is also possible.

In addition, detailed configurations of respective devices constituting the image forming apparatus and detailed operations thereof may be modified as appropriate without departing from the spirit and scope of the present disclosure.

Although embodiments of the present invention have been described and illustrated in detail, the disclosed embodiments are provided for purposes of illustration and example only and not by way of limitation. The scope of the present invention should be construed in accordance with the appended claims.

What is claimed is:

1. An image forming apparatus comprising:
a sensor configured to detect a toner amount of a fogged image formed on an image bearing member; and
a hardware processor that:
makes a stepwise change to a fogging margin;
acquires the toner amount of the fogged image formed on the image bearing member according to the stepwise change in the fogging margin, the toner amount being detected by the sensor; and
sets the fogging margin based on the acquired toner amount, wherein
the fogging margin includes a first fogging margin in a non-image region, and
the hardware processor sets the first fogging margin to a value corresponding to a predetermined difference value with respect to a saturation value of the acquired toner amount.

2. The image forming apparatus according to claim 1, wherein
the fogging margin includes a second fogging margin in an image region, and
the hardware processor sets the second fogging margin based on a change point of the acquired toner amount.

3. The image forming apparatus according to claim 2, wherein the second fogging margin in the image region and the first fogging margin in the non-image region have different values.

4. The image forming apparatus according to claim 2, wherein the second fogging margin in the image region and the first fogging margin in the non-image region have a same value.

5. The image forming apparatus according to claim 1, further comprising an exposurer configured to form an electrostatic latent image on a charged photoreceptor, wherein the exposurer does not form the electrostatic latent image in the non-image region.

6. A fogging margin setting method executed by an image forming apparatus that includes a sensor configured to detect a toner amount of a fogged image formed on an image bearing member, the fogging margin setting method comprising:
making a stepwise change to a fogging margin;
acquiring the toner amount of the fogged image formed on the image bearing member according to the stepwise change in the fogging margin made in the making, the toner amount being detected by the sensor; and
setting the fogging margin based on the toner amount acquired in the acquiring, wherein
the fogging margin includes a first fogging margin in a non-image region, and
the setting includes setting the first fogging margin to a value corresponding to a predetermined difference value with respect to a saturation value of the toner amount acquired in the acquiring.

7. A non-transitory computer-readable storage medium storing a program that causes a computer of an image forming apparatus that includes a sensor configured to detect a toner amount of a fogged image formed on an image bearing member to function as:
a changing section that makes a stepwise change to a fogging margin;
an acquisition section that acquires the toner amount of the fogged image formed on the image bearing member according to the stepwise change in the fogging margin made by the changing section, the toner amount being detected by the sensor; and
a setting section that sets the fogging margin based on the toner amount acquired by the acquisition section, wherein
the fogging margin includes a first fogging margin in a non-image region, and
the setting section sets the first fogging margin to a value corresponding to a predetermined difference value with respect to a saturation value of the toner amount acquired by the acquisition section.
